(19) United States
(12) Patent Application Publication
(10) Pub. No.: US 2004/0037078 A1
(43) Pub. Date: Feb. 26, 2004

(54) Display device

(75) Inventor: Seungsoo Lee, Monroe, NJ (US)

Correspondence Address: John K. Kim, McCarter & English, LLP, Four Gateway Center, 100 Mulberry Street, Newark, NJ, 07102, US

(73) Assignee: Joy World, Inc.

(21) Appl. No.: 10/645,792

(22) Filed: Aug. 21, 2003

Related U.S. Application Data
(60) Provisional application No. 60/405,218, filed on Aug. 22, 2002.

(51) Int. Cl. F21V 21/00

(52) U.S. Cl. 362/249

(57) ABSTRACT

A display device includes a case, which has a surface for supporting an article thereon, a plurality of light units and an activating mechanism for activating the light units in a predetermined manner. A supporting member is mounted in the case for supporting the light units therefrom such that at least one portion of each of the light units extends outwardly from the case. The supporting member has at least one printed circuit thereon for connecting the light units to the activating mechanism.

### CROSS-REFERENCE TO RELATED APPLICATION

This is a non-provisional application relating to U.S. Provisional Application Serial No. 60/405,218 filed Aug. 22, 2002, the disclosure of which is incorporated herein by reference.

### FIELD OF THE INVENTION

The present invention relates to display devices and the like and, more particularly, to a display device adapted to support a food item thereon and generate special effects, such as audible sounds and visible lights.

### BACKGROUND OF THE INVENTION

Light-accented trays or display devices have been developed in the past for serving or displaying food items. For instance, U.S. Pat. No. 1,847,687 discloses a cake display device having a plurality of illuminated decorations (i.e., light bulbs) thereon, while U.S. Pat. No. 3,705,982 discloses a serving tray equipped with a penlight flashlight. While various improvements have been made on these trays and display devices (see, e.g., U.S. Pat. Nos. 4,640,033, 4,803,604, 5,355,289, 5,430,628 and 6,152,575), there is still a need for an improved light-accented display device and the like.

### SUMMARY OF THE INVENTION

The present invention overcomes the disadvantages and shortcomings discussed above by providing an improved light-accented display device. More particularly, the device includes a case, which has a plurality of openings therein, and a plurality of light units, which are mounted in the case. Each of the light units has a portion extending outwardly through a corresponding one of the openings. The device also includes a strip having a plurality of conductive paths deposited thereon. Each of the light units is attached to the strip such that it is connected to a corresponding pair of the conductive paths. A printed circuit board is also mounted in the case and includes controlling means for controlling the operation of the light units. The strip is attached to the board such that the controlling means is electrically connected to the conductive paths.

### BRIEF DESCRIPTION OF THE DRAWINGS

For a more complete understanding of the present invention, reference is made to the following detailed description of the present invention considered in conjunction with the accompanying drawings, in which:

FIG. 1 is a perspective view of a display device constructed in accordance with a first embodiment of the present invention;

FIG. 2 is a perspective view of the display device shown in FIG. 1, the display device being in an upside-down position;

FIG. 3 is an exploded perspective view of the display device shown in FIGS. 1 and 2;

FIG. 4a is a partially exploded view of an electronic circuit assembly utilized in the display device shown in FIGS. 1-3;

FIG. 4b is an assembled view of the electronic circuit assembly shown in FIG. 4a, looking from a different direction;

FIG. 5 is a cross-sectional view, taken along section line V-V and looking in the direction of the arrows, of the display device shown in FIG. 1;

FIG. 6 is a cross-sectional view, taken along section line VI-VI and looking in the direction of the arrows, of the display device shown in FIG. 1;

FIG. 7 is a cross-sectional view, taken along section line VII-VII and looking in the direction of the arrows, of the display device shown in FIG. 1;

FIG. 8 is a schematic illustration of a jig utilized in assembling the electronic circuit assembly shown in FIGS. 4a and 4b;

FIGS. 9a-9c are schematic views illustrating the process of assembling the display device shown in FIGS. 1-3;

FIG. 10 is an enlarged view of a section of the display device shown in FIG. 9c;

FIG. 11 is a simplified plan view of a section of the electronic circuit assembly shown in FIGS. 4a and 4b;

FIG. 12 is a diagrammatical view of the display device shown in FIGS. 1-3 stacked with identical display devices;

FIG. 13 is a view of a modification to the display device shown in FIGS. 1-3;

FIG. 14 is an exploded perspective view of a display device constructed in accordance with a second embodiment of the present invention;

FIG. 15 is a cross-sectional view of the display device shown in FIG. 14;

FIG. 16 is a perspective view of an electronic circuit assembly of a display device constructed in accordance with a third embodiment of the present invention;

FIG. 17 is a partial cross-sectional view of the electronic circuit assembly shown in FIG. 16;

FIG. 18 is an exploded perspective view of a display device constructed in accordance with a fourth embodiment of the present invention;

FIG. 19 is a cross-sectional view of the display device shown in FIG. 18;

FIG. 20 is an exploded perspective view of a display device constructed in accordance with a fifth embodiment of the present invention;

FIG. 21 is a perspective view of an electronic circuit assembly of a display device constructed in accordance with a sixth embodiment of the present invention;

FIG. 22 is an exploded perspective view of a display device constructed in accordance with a seventh embodiment of the present invention; and

FIG. 23 is a perspective view of a display device constructed in accordance with an eighth embodiment of the present invention.

### DETAILED DESCRIPTION OF THE EXEMPLARY EMBODIMENTS

Although the present invention can be used in conjunction with any type of tray, stand or display device, it is particularly suitable for use in connection with a cake display stand. Accordingly, the present invention will be described hereinafter in connection with a cake display stand. It should be understood, however, that the following description is only meant to be illustrative of the present invention and is not meant to limit the scope of the present invention, which has applicability to other types of trays, stands or displays.

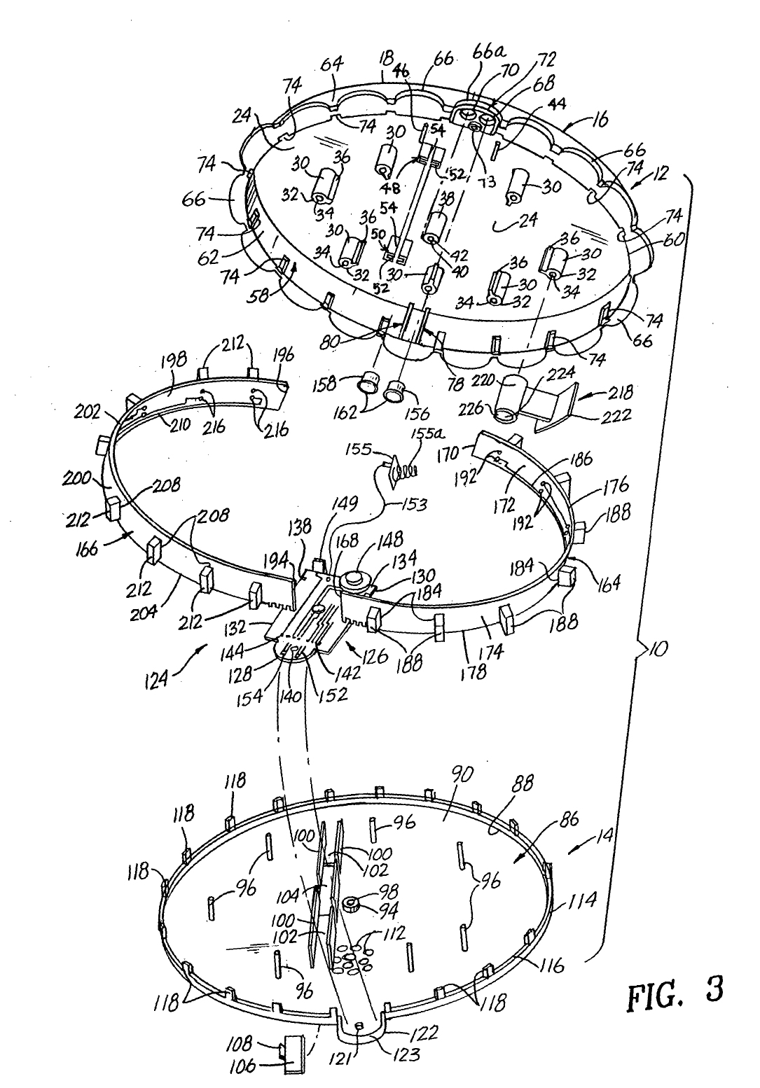

Referring to FIGS. 1-3, there is shown a cake display stand 10 constructed in accordance with a first embodiment of the present invention. More particularly, the stand 10, which is adapted to generate special effects (e.g., audible sounds, visible lights, etc.) for enhancing amusement at gatherings or celebrations, includes an upper section 12 and a lower section 14 attached to one another. The upper section 12, which is preferably formed as a single piece by a conventional molding process, includes a platform 16 having a substantially circular shape and including a periphery 18. The platform 16 is oriented substantially horizontally for supporting a cake 20 thereon and is provided with an upper side 22 (see FIGS. 1 and 5) and a lower side 24 (see FIGS. 3 and 5). The upper side 22 of the platform 16 includes an outer annular groove 26 formed therein and arranged substantially concentric with respect to the periphery 18. An inner annular groove 28 is also formed in the upper side 22 of the platform 16 and arranged substantially concentric relative to the outer groove 26.

Now referring to FIG. 3, the lower side 24 of the platform 16 has an array of support columns 30 depending vertically downwardly therefrom and arranged in circular fashion. Each of the support columns 30 has a lower end 32, a hole 34 and a stop 36. Each of the stops 36 extends radially inwardly from a corresponding one of the support columns 30 for purposes to be discussed hereinafter. A screw column 38 depends vertically downwardly from the lower side 24 of the platform 16 and is located substantially centrally on the lower side 24. The screw column 38 has a lower end 40 and is provided with a hole 42. Retaining pins 44, 46 also depend from the lower side 24. Still referring to FIG. 3, electric contact holders 48, 50 depend from the lower side 24. Each of the contact holders 48, 50 is provided with a slit 52 and a groove 54 for purposes to be discussed hereinafter.

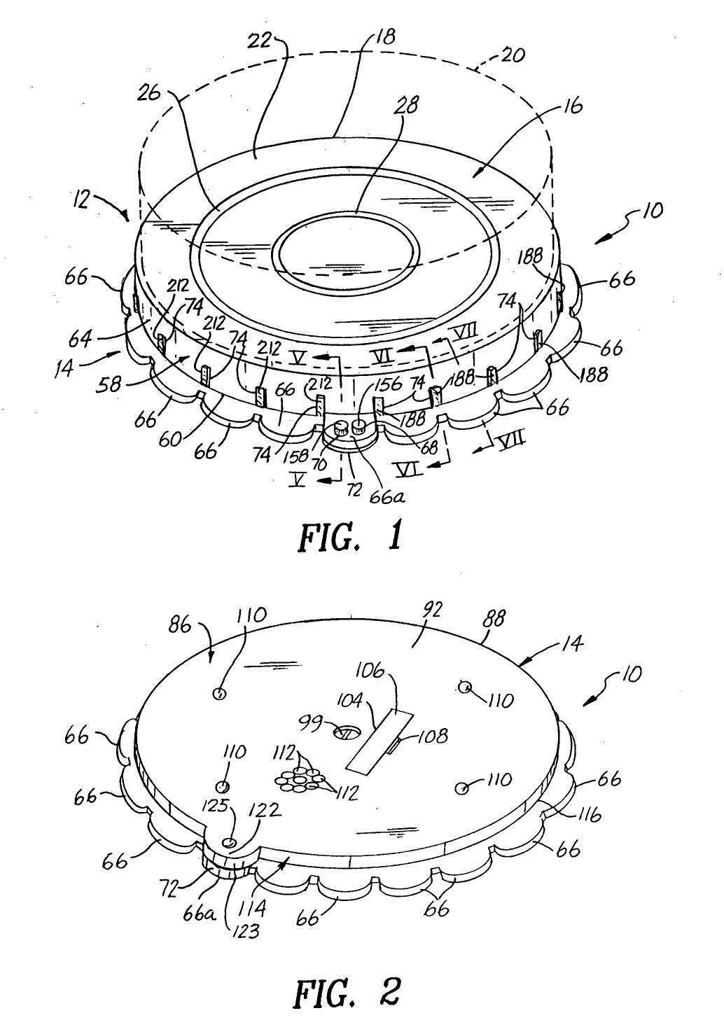

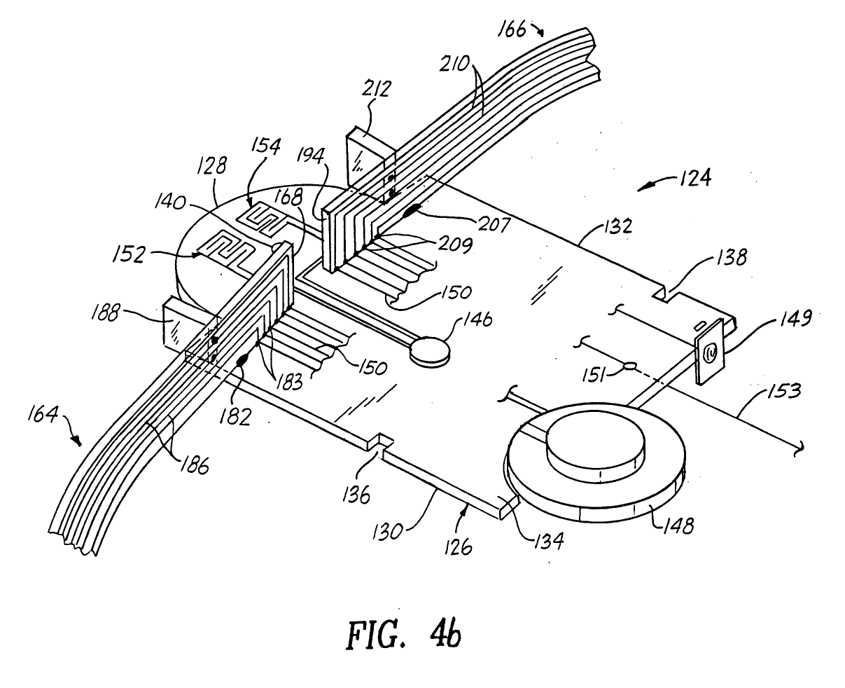

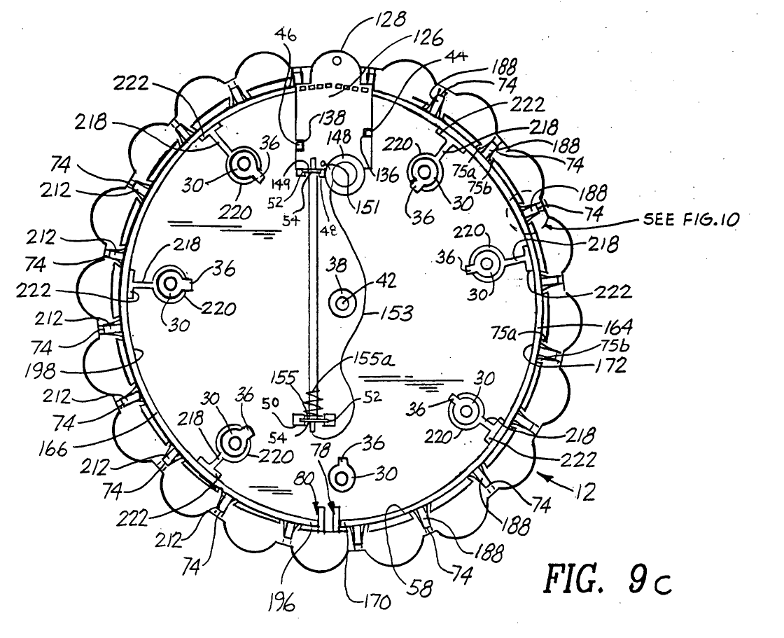

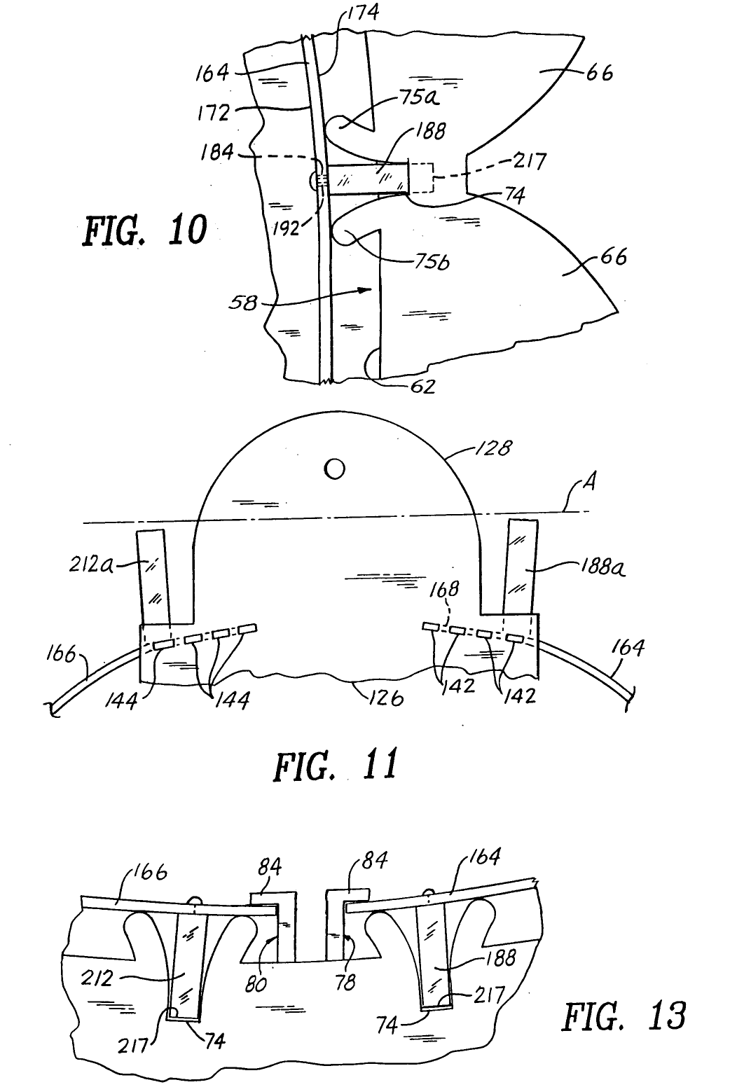

With reference to FIGS. 1, 3, 5 and 6, an annular side wall 58 depends vertically downwardly from the periphery 18 of the platform 16. The side wall 58 has a lower end 60 opposite the platform 16, as well as an inner surface 62 and an outer surface 64 which is located radially outwardly from the inner surface 62 (see FIG. 5). The side wall 58 is also provided with a series of ornamental leaves 66 projecting horizontally outwardly from the outer surface 64 adjacent to the lower end 60. One of the leaves (referred to hereinafter as “the switch leaf 66a”) has a pair of openings 68, 70 and a lateral rim 72 (see FIGS. 2, 5 and 6) depending therefrom for purposes to be discussed hereinafter. The switch leaf 66a is also provided with a column 73 depending therefrom. Slots (i.e., openings) 74 are formed in the side wall 58 and extend vertically upwardly from the lower end 60 toward the platform 16. More particularly, each of the slots 74, which are arranged in an equally spaced manner along the side wall 58, is positioned substantially centrally between a corresponding pair of the leaves 66 and extends completely through the side wall 58 between the inner and outer surfaces 62, 64. Guiding members 75a, 75b (see FIGS. 9c and 10) project inwardly from the side wall 58 adjacent to each of the slots 74 and flare away from each other as they extend away from the side wall 58. More particularly, each of the slots 74 is located between a corresponding pair of the guiding members 75a, 75b for purposes to be discussed hereinafter. A groove 76 (see FIG. 7) is also formed in the lower end 60 of the side wall 58 between each adjacent pair of the slots 74.

Referring to FIGS. 3 and 9c, retainers 78, 80 depend from the lower side 24 of the upper section 12 and are positioned substantially opposite from the switch leaf 66a. More particularly, each of the retainers 78, 80 projects radially inwardly from the inner surface 62 of the side wall 58 and has a height which is substantially identical to the height of the side wall 58 of the upper section 12 for purposes to be discussed hereinafter.

With reference to FIG. 3, the lower section 14 of the stand 10 has a base 86 oriented in a substantially horizontal manner. The base 86 has a size and shape similar to those of the platform 16 of the upper section 12 and has a periphery 88, as well as an upper side 90 and a lower side 92 (see FIGS. 5 and 6). A screw column 94 and mounting pegs 96 extend vertically upwardly from the upper side 90 of the base 86. The screw column 94 is located substantially centrally on the upper side 90 of the base 86 such that it is aligned with the screw column 38 of the upper section 12. An opening 98 extends completely through the screw column 94. In this manner, a screw 99 (see FIG. 2) can extend through the screw column 94 and be threaded into the hole 42 of the screw column 38 of the upper section 12, thereby securing the lower section 14 to the upper section 12. The mounting pegs 96 are arranged in an annular fashion such that each of them is received in a corresponding one of the holes 34 of the support columns 30 (see FIG. 6). In this manner, the mounting pegs 96 and the support columns 30 cooperate to further secure the upper section 12 to the lower section 14. The mounting pegs 96 and the support columns 30 also function to inhibit lateral movement of the upper section 12 relative to the lower section 14.

Now referring to FIG. 6, each of the support columns 30 is provided with a sufficient height such that the lower ends 32 of the support columns 30 come in contact with (i.e., rest on) the upper side 90 of the lower section 14. The screw column 38 of the upper section 12 is also provided with a sufficient height such that its lower end 40 comes in contact with (i.e., rests on) the screw column 94 of the lower section 14. In this manner, the support columns 30 and the screw column 38 provide support for the platform 16 and hence the cake 20 or food items placed thereon.

Battery housing plates 100 project upwardly from the upper side 90 of the base 86 (see FIG. 3). More particularly, the plates 100 are arranged such that a battery cage 102 is formed for receiving a set of standard replaceable or rechargeable batteries therein in serial fashion. The contact holders 48, 50 of the upper section 12 are positioned at opposing ends of the battery cage 102 so as to retain batteries therebetween. An access opening 104 is formed in the base 86 and aligned with the battery cage 102, while an access cover 106 is removably attached to the base 86 for closing off the access opening 104. The access cover 106 has a latch 108 for releasably securing the access cover 106 to the base 86. In this manner, batteries can be inserted into the battery cage 102 through the access opening 104 and be housed in the battery cage 102.

The lower side 92 of the base 86 is provided with a plurality of support pegs 110 (see FIGS. 2, 5 and 6) depending therefrom for supporting the stand 10 on a supporting surface (e.g., a table) such that the leaves 66 of the upper section 12 is spaced upwardly from the supporting surface. In such circumstances, the stand 10 can be lifted easily from the supporting surface by gripping one or more of the leaves 66 of the upper section 12. Sound-transmitting holes 112 (see FIGS. 2 and 3) are also formed completely through the base 86 for facilitating the transmission of audible sounds generated within the stand 10 to the exterior of the stand 10. In this regard, because of the support pegs 110, when the stand 10 is placed on a supporting surface, the base 86 is spaced from the supporting surface, thereby further facilitating the transmission of such sounds through the sound transmission holes 112.

With reference to FIGS. 2, 3, 5 and 6, a side wall 114 projects upwardly from the periphery 88 of the base 86 and has an upper end 116 opposite the base 86. Posts 118 extend vertically upwardly from the upper end 116 of the side wall 114. Each of the posts 118 projects into a corresponding one of the slots 74 of the upper section 12 (see FIG. 6). Tongues 120 (see FIG. 7) are also provided on the upper end 116 of the side wall 114. More particularly, each of the tongues 120 is arranged between an adjacent pair of the posts 118 and is received in a corresponding one of the grooves 76 of the side wall 58 of the upper section 12 (see FIG. 7) so as to prevent lateral movement of the side wall 114 of the lower section 14 relative to the side wall 58 of the upper section 12. Alternatively, the tongues 120 and the grooves 76 can be eliminated. A support leaf 122 (see FIGS. 3, 5 and 6) extends horizontally outwardly from the side wall 114 such that the switch leaf 66a of the upper section 12 is superimposed over the support leaf 122 (see FIG. 5) for purposes to be discussed hereinafter. The support leaf 122 has a retaining pin 121 projecting upwardly therefrom so as to be received in the column 73 of the switch leaf 66a. A lateral rim 123 also projects upwardly from a peripheral boundary of the support leaf 122. The lateral rim 123 of the support leaf 122 abuts the lateral rim 72 of the switch leaf 66a (see FIGS. 5 and 6). A support peg 125 also depends from the support leaf 122 so as to provide support therefor. With the exception of the access cover 106, the lower section 14 is preferably formed as a single piece by a conventional molding process.

Now referring to FIGS. 3-5, the stand 10 has an electronic circuit assembly 124 mounted in the stand 10 between the upper and lower sections 12, 14. The electronic circuit assembly 124 includes a substantially flat printed circuit board 126 having an arcuate section 128 at one end thereof, a pair of lateral sides 130, 132 and an upper side 134. The arcuate section 128 is positioned between the support leaf 122 of the lower section 14 and the switch leaf 66a of the upper section 12 (see FIG. 5). In this regard, the lateral rims 72, 123 of the switch leaf 66a and the support leaf 122, respectively, laterally enclose the arcuate section 128 (see FIGS. 1, 2 and 5). Notches 136, 138 are formed in the sides 130, 132, respectively, of the circuit board 126, while a hole 140 is formed in the arcuate section 128. The retaining pins 44, 46 of the upper section 12 and the retaining pin 121 of the support leaf 122 extend through the notches 136, 138 and the hole 140, respectively, so as to secure the circuit board 126 in the stand 10 (see FIGS. 5 and 9c). Mounting holes 142, 144 are also formed in the circuit board 126 for purpose to be discussed hereinafter.

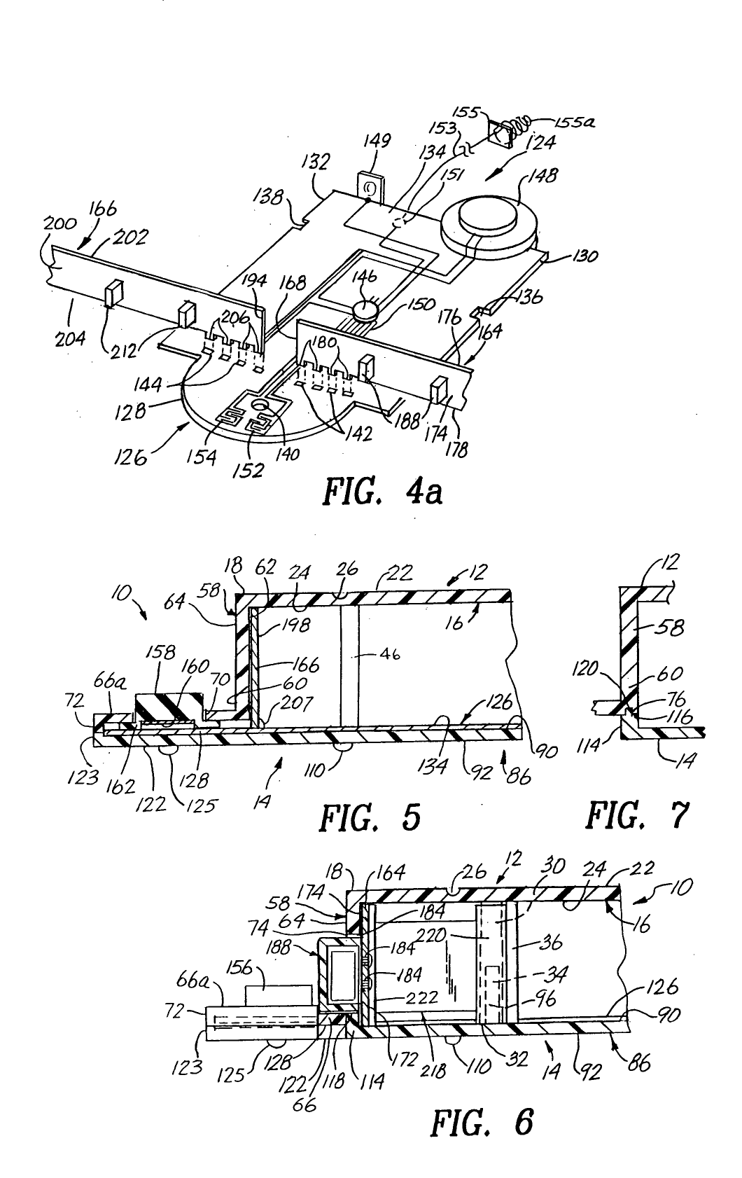

With reference to FIG. 4a, an integrated circuit unit (hereinafter “the ICU”) or a microprocessor 146 is mounted on the circuit board 126 for controlling the operation of the electronic circuit assembly 124. A speaker 148 is also mounted on the circuit board 126 for generating audible sounds in response to a signal received from the ICU 146. The circuit board 126 can be equipped with other conventional electrical or electronic components. The circuit board 126 has a printed circuit or printed circuits 150 (i.e., conductive leads or paths) formed or deposited thereon for electrically connecting various electronic or electrical components of the circuit board 126, such as the ICU 146 and the speaker 148, in a conventional manner. A contact plate 149 is mounted to the circuit board 126 opposite the arcuate section 128 and is received in the slit 52 (see FIGS. 3 and 9c) of the contact holder 48 for engaging, through the groove 54 of the contact holder 48, a positive end of a battery inserted into the battery cage 102. A contact 151 is also formed on the circuit board 126, while a wire 153 is connected to the contact 151 at one end thereof. A contact plate 155 is connected to an opposite end of the wire 153 and has a spring 155a projecting therefrom. The contact plate 155 is received in the slit 52 of the contact holder 46 of the upper section 12 such that the spring 155a extends into the battery cage 102 through the groove 54 (see FIG. 9c) for engaging a negative end of a battery received in the battery cage 102 so as to provide electricity to the electronic circuit assembly 124.

Still referring to FIG. 4a, the circuit board 126 includes a pair of switch leads 152 and a pair of switch leads 154 positioned in part on the arcuate section 128. The switch leads 152 are electrically isolated from each other, while the switch leads 154 are electrically isolated from each other. The switch leads 152 and the switch leads 154 are positioned such that they are aligned substantially vertically relative to the openings 68, 70, respectively, of the switch leaf 66a of the upper section 12. Buttons 156, 158 (see FIGS. 1, 3, 5 and 6) are mounted in the openings 68, 70, respectively, of the switch leaf 66a. More particularly, each of the buttons 156, 158 has a conductive plate 160 and an annular support rim 162 such that the conductive plate 160 is normally out of contact with a corresponding pair of the switch leads 152, 154 (see FIG. 5). Each of the support rims 162 of the buttons 156, 158 is flexible such that, when a corresponding one of the buttons 156, 158 is depressed by a user, the conductive plate 160 is engageable with a corresponding pair of the switch leads 152, 154 so as to close an associated switch circuit of the electronic circuit assembly 124. In this regard, the support leaf 122 of the lower section 14, in conjunction with the support peg 125, functions to support the arcuate section 128 of the circuit board 126 when the button 156 or the button 158 is depressed, thereby facilitating engagement between the conductive plates 160 of the buttons 156, 158 and the switch leads 152, 154, respectively.

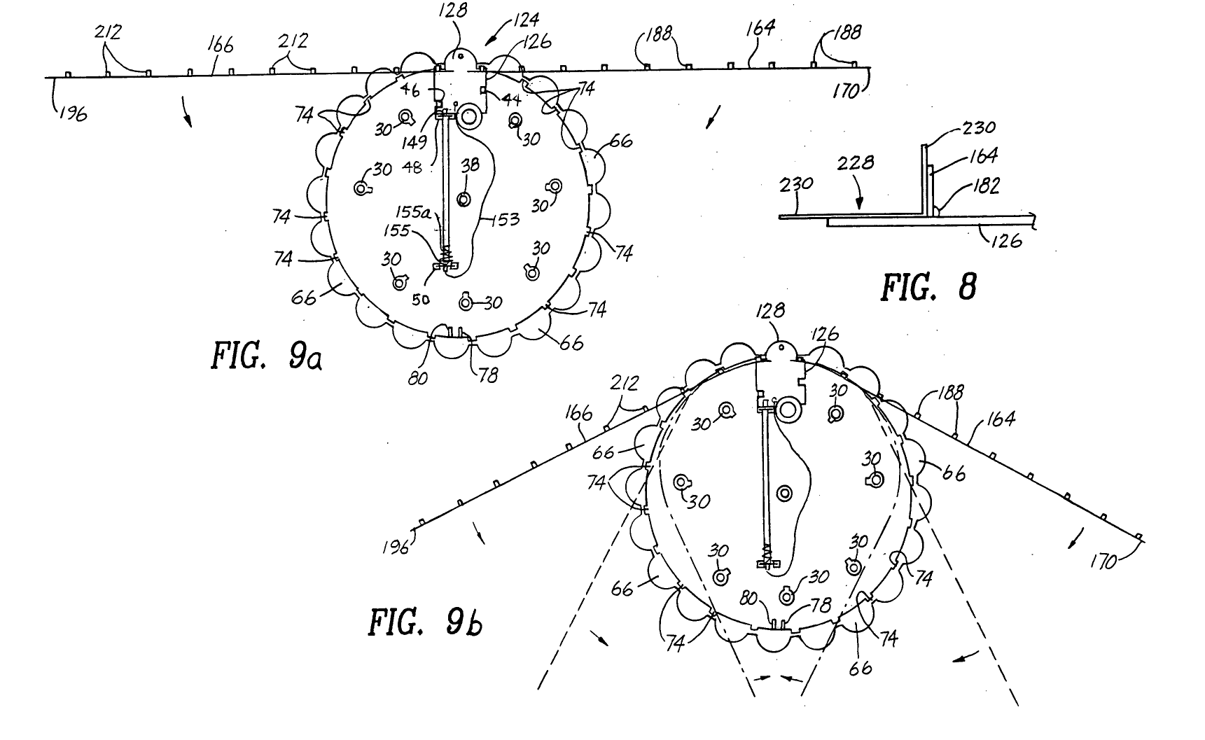

Now referring to FIGS. 3-6, the electronic circuit assembly 124 is also equipped with a pair of printed circuit board strips 164, 166. More particularly, the strip 164 has a pair of opposing ends 168, 170, inner and outer sides 172, 174 and upper and lower edges 176, 178. Each of the inner and outer sides 172, 174 has a width (i.e., a distance measured between the upper and lower edges. 176, 178) which is substantially greater than the thickness of the upper edge 176 or the lower edge 178 (i.e., a distance measured between the inner and outer sides 172, 174). The lower edge 178 is provided with a plurality of teeth 180 adjacent to the end 168. Each of the teeth 180 is received in a corresponding one of the mounting holes 142 of the circuit board 126 so as to secure the strip 164 to the upper side 134 of the circuit board 126. In this regard, the strip 164 is attached to the circuit board 126 such that the inner and outer sides 172, 174 are substantially perpendicular to the upper side 134 of the circuit board 126 (i.e., the upper and lower edges 176, 178 are substantially parallel to the upper side 134 of the circuit board 126). The strip 164 is secured to the circuit board 126 in its perpendicular orientation by a soldered joint 182 (see FIGS. 4b and 8). Alternatively, other attaching mechanisms can be used to secure the strip 164 to the circuit board 126. Holes 184 (see FIGS. 6 and 10) are also formed in the strip 164, extending through the inner and outer sides 172, 174 and are arranged in a spaced manner along the length of the strip 164. Printed circuits 186 (i.e., conductive paths or leads) are also formed (i.e., deposited) on the inner side 172 of the strip 164 and are connected to the printed circuit or circuits 150 of the circuit board 126 through soldered joints 183 (see FIG. 4b).

With reference to FIGS. 1, 3, 4 and 6, the strip 164 is also provided with light emitting diodes 188 (hereinafter “LEDs”), each of which has a pair of leads 192 at an end thereof. As is conventional in the LED field, each of the LEDs 188 is illuminated in response to the application of electricity to a corresponding pair of the leads 192. Each of the LEDs 188 is mounted to the strip 164 such that it projects radially outwardly from the outer side 174 of the strip 164 (see FIGS. 6, 9c and 10). The leads 192 of each of the LEDs 188 are inserted through a corresponding pair of the holes 184 and are then securely attached (e.g., soldered) to the inner side 172 of the strip 164 so as to be connected to a corresponding one or pair of the printed circuits 186 in accordance with a predetermined circuit design.

Referring back to FIGS. 3-6, the strip 166 has a pair of opposing ends 194, 196, inner and outer sides 198, 200 and upper and lower edges 202, 204. Each of the inner and outer sides 198, 200 has a width (i.e., a distance measured between the upper and lower edges 202, 204) which is substantially greater than the thickness of the upper edge 202 or the lower edge 204 (i.e., a distance measured between the inner and outer sides 198, 200). The lower edge 204 is provided with a plurality of teeth 206 adjacent to the end 194. Each of the teeth 206 is received in a corresponding one of the mounting holes 144 of the circuit board 126 (see FIG. 4a) so as to secure the strip 166 to the upper side 134 of the circuit board 126. In this regard, the strip 166 is attached to the circuit board 126 such that the inner and outer sides 198, 200 are substantially perpendicular to the upper side 134 of the circuit board 126 (i.e., the upper and lower edges 202, 204 are substantially parallel to the upper side 134 of the circuit board 126). The strip 166 is secured to the circuit board 126 in its perpendicular orientation by a soldered joint 207 (see FIGS. 4b and 5). Alternatively, other attaching mechanisms can be used to secure the strip 166 to the circuit board 126. Holes (not shown) are formed in the strip 166, extending through the inner and outer sides 198, 200 and arranged in a spaced manner along the length of the strip 166. Printed circuits 210 (i.e., conductive paths or leads) are also formed (i.e., deposited) on the inner side 198 of the strip 166 and are connected to the printed circuit or circuits 150 of the circuit board 126 through the soldered joints 209 (see FIG. 4b).

With reference to FIGS. 1, 3 and 4a, the strip 166 is also provided with light emitting diodes 212 (hereinafter “LEDs”), each of which has a pair of leads 216 at an end thereof. As is conventional in the LED field, each of the LEDs 212 is illuminated in response to the application of electricity to a corresponding pair of the leads 216. Each of the LEDs 212 is mounted to the strip 166 such that it projects radially outwardly from the outer side 200 of the strip 166 (see FIGS. 3, 4a and 9c). The leads 216 of each of the LEDs 212 are inserted through the holes of the strip 166 and securely attached (e.g., soldered) to the inner side 198 of the strip 166 so as to be connected to a corresponding one or pair of the printed circuits 210 in accordance with a predetermined circuit design.

With reference to FIGS. 3 and 9c, each of the strips 164, 166, which are normally straight or flat, is curved into a substantially semi-circular shape and is mounted in the stand 10 such that each of the LEDs 188, 212 is received in a corresponding one of the slots 74 of the upper section 12. More particularly, each of the LEDs 188, 212 extends radially outwardly from the outer surface 64 of the side wall 58 of the upper section 12 through a corresponding one of the slots 74 such that the LEDs 188, 212 are visible (see FIGS. 1 and 6). In this regard, each of the LEDs 188, 212 extends beyond a corresponding one of the slots 74 (see FIG. 10). As a result, a free end 217 of each of the LEDs 188, 212 is supported on a corresponding one or pair of the leaves 66 (see FIG. 10). Each of the posts 118 of the lower section 14 is also received in a corresponding one of the slots 74 below a corresponding one of LEDs 188, 212 (see FIG. 6) such that the LEDs 188, 212 are further secured in the slots 74. Alternatively, the posts 118 can be eliminated.

While the strips 164, 166 can be made from any materials typically used for making conventional printed circuit boards (“PCBs”), they have a thickness that is smaller than those of conventional PCBs. More particularly, because the leads 192 of the LEDs 188 and the leads 216 of the LEDS 212 are soldered to the inner sides 172, 198, respectively, of the strips 164, 166, respectively, the strips 164, 166 are preferably provided with a thickness small enough to prevent the soldered attachments from being detached from the strips 164, 166 when the strips 164, 166 are bent into their semi-circular shape from their flat or straight form. For instance, while the thickness of conventional PCBs is about 1.5 mm, each of the strips 164, 166 can preferably be provided with a thickness of about 0.5 mm. Other thicknesses can also be used, depending upon the type and size of solder used. Moreover, if the leads 192 of the LEDs 188 and the leads 216 of the LEDs 212 are attached to the strips 164, 166, respectively, by different mechanisms, the strips 164, 166 can be provided with any thickness sufficient to permit them to be curved into a semi-circular shape.

With reference to FIG. 11, the mounting holes 142, 144 of the circuit board 126 are arranged such that the LEDs 188, 212, respectively, positioned adjacent thereto (referred to hereinafter as “the LEDs 188a, 212a”) are inhibited from being disconnected from the strips 164, 166, respectively, when the strips, 164, 166 are curved into a semi-circular shape. More particularly, the mounting holes 142 are arranged linearly in a direction that is slanted at a sufficient angle relative to a transverse axis A of the circuit board 126 (i.e., an axis substantially perpendicular to the longitudinal axis of the circuit board 126) such that the end 168 of the strip 164, including the location at which the LED 188a is attached to, is kept substantially straight. In this manner, the strip 164 is bent at a location beyond the LED 188a and hence inhibits detachment of the lead 192 of the LED 188a from the strip 164. The mounting holes 144 are arranged in a manner similar to the manner discussed above in connection with the mounting holes 142 in order to achieve a similar result.

The various electrical or electronic components of the electronic circuit assembly 124 are connected in a conventional manner so as to generate special effects (i.e., cause the LEDs 188, 212 to be illuminated and the speaker 148 to produce audible sounds) when the button 156 or the button 158 is depressed. In this regard, the electronic circuit assembly 124 can be equipped with any conventional circuitry. Circuitry suitable for use in connection with the present invention is well known and is hence within the knowledge of a person skilled in the art.

Referring to FIGS. 3, 6 and 9c, the stand 10 is also provided with a plurality of support bars 218, each of which is mounted to a corresponding one of the support columns 30 of the upper section 12. More particularly, each of the bars 218 is provided with a mounting end 220 and a support plate 222 opposite to the mounting end 220. The mounting end 220 of each of the bars 218 has an opening 224 for receiving a corresponding one of the support columns 30 and a slot 226 for receiving a corresponding one of the stops 36 of the support columns 30 (see FIG. 6). In this manner, each of the bars 218 is inhibited from moving or rotating relative to its corresponding support column 30. Each of the mounting ends 220 is also provided with a height substantially equal to those of the support columns 30 such that it is inhibited from moving vertically relative to the stand 10 (i.e., the mounting ends 220 are retained between the platform 16 of the upper section 12 and the base 86 of the lower section 14). The support plate 222 of each of the bars 218 engages a corresponding one of the inner sides 172, 198 of the strips 164, 166, respectively, so as to secure the strips 164, 166 in the stand 10 in their semi-circular shape (see FIGS. 6 and 9c). In this regard, each of the support plates 222 have an arc shape so as to correspond to the curvature of the strips 164, 166.

Referring primarily to FIG. 9c, each of the support bars 218 is provided with a substantially identical length to engage a corresponding one of the strips 164, 166. Because the leads 192 of the LEDs 188 and the leads 216 of the LEDs 212 are attached to the strips 164, 166, respectively, by solders, the strips 164, 166 have varying thicknesses at locations where the LEDs 188, 216 are attached. As a result, the support columns 30 of the upper section 12 are arranged such that the support plates 222 of the support bars 218 avoid directly engaging such locations.

In use, when the button 156 is depressed, the conductive plate 160 of the button 156 comes in contact with the switch leads 152 of the circuit board 126, thereby closing an associated switch circuit (not shown) of the electronic circuit assembly 124. In response, the ICU 146 of the electronic circuit assembly 124 activates the LEDs 188, 212 in a predetermined (i.e., pre-programmed) sequence or pattern, creating visual effects. For instance, the LEDs 188, 212 can blink sequentially so as to provide the appearance of a moving or rotating light. A signal is also sent from the ICU 146 to the speaker 148 such that audible sounds (e.g., a “Happy Birthday” tune) are produced by the speaker 148. The electronic circuit assembly 124 is in its activated state until the button 156 is depressed again. In this regard, the number of the LEDs 188, 212 can vary depending upon the size and shape of the stand 10 and/or the visual effects desired. For instance, 20 to 30 LEDs can be spaced apart from one another by about 3 cm-5 cm for creating the effect of a moving or rotating light for a cake stand having a circumference of about 70 cm-100 cm.

The button 158 is provided for testing the operation of the stand 10. More particularly, when the button 158 is depressed and its conductive plate 160 comes in contact with the switch leads 154 of the circuit board 126, the electronic circuit assembly 124 is activated (e.g., it causes the LEDs 188, 212 to blink in a predetermined manner and the speaker 148 to generate audible sounds). After the lapse of a predetermined time period, the electronic circuit assembly 124 deactivates automatically.

Since the button 158 is provided for testing purposes, the stand 10 can be packaged for sale in a transparent package (or a package having a transparent window) with only the button 158 exposed for use by potential purchasers. More particularly, the button 158 can be depressed by a potential buyer to see or examine the operation of the stand 10.

While the stand 10 can be assembled in many different ways, it can be assembled in the following preferred manner. The LEDs 188, 212 are mounted to the strips 164, 166, respectively, and their leads 192 and leads 216, respectively, are soldered to same in the manner discussed above. The strips 164, 166 are then attached (e.g., soldered) to the circuit board 126 such that the strips 164, 166 are substantially perpendicular to the circuit board 126. In this regard, a jig 228 having perpendicularly oriented sides 230 are used to pre-position the strips 164, 166 in their desired orientations (see FIG. 8). More particularly, with the jig 228 positioned on the circuit board 126, the strips 164, 166 are, either individually or collectively, laid against a corresponding one of the sides 230 of the jig 228. The solder joints 182, 207, as well as the solder joints 183, 209, (see FIGS. 4b, 5 and 8) are then formed in a conventional manner so as to affix the strips 164, 166, respectively, to the circuit board 126.

After fixedly attaching (e.g., soldering) the strips 164, 166 to the circuit board 126 and hence forming the electronic circuit assembly 124, the electronic circuit assembly 124 is pre-positioned in the upper section 12 of the stand 10. In order to do so, the upper section 12 is placed on a supporting surface (e.g., an assembly table) in an upside-down or flipped manner such that the upper side 22 of the upper section 12 rests on the supporting surface (i.e., the lower side 24 of the upper section 12 faces upwardly) The buttons 156, 158 are then mounted in the openings 68, 70, respectively, of the switch leaf 66a. Next, with the strips 164, 166 oriented substantially linearly, the arcuate section 128 of the circuit board 126 is placed on the switch leaf 66a of the upper section 12 such that the retaining pins 44, 46 are inserted into the notches 136, 138, respectively, of the circuit board 126 (see FIG. 9a). The contact plates 149, 155 of the electronic circuit assembly 124 are also inserted into the slits 52 of the contact holders 48, 50, respectively, of the upper section 12. With the ends 170, 196 of the strips 164, 166, respectively, being pulled toward the retainers 78, 80 (as indicated by the arrows in FIG. 9b), the LEDs 188, 212 are placed into the slots 74. In this regard, each pair of the guiding members 75a, 75b facilitates the insertion of a corresponding one of the LEDs 188, 212 into a corresponding one of the slots 74 (see FIG. 10).

After the LEDs 188, 212 are properly placed in the slots 72, the ends 170, 196 of the strips 164, 166, respectively, are then placed against the retainers 78, 80, respectively, so as to substantially maintain the curved shape of the strips 164, 166 (see FIG. 9c). Next, each of the bars 218 is mounted to a corresponding one of the support columns 30 such that the support plates 222 bear against the inner sides 172, 198 of the strips 164, 166, respectively, so as to ensure that the strips 164, 166 are securely mounted in the upper section 12 (see FIG. 9c) in their curved shape (i.e., the strips 164, 166 substantially conform to the curvature of the side wall 58 of the upper section 12). Due to the provision of the retainers 78, 80, the support column 30 of the upper section 12 located adjacent to same is not provided with a support bar. The lower section 14 is then attached to the upper section 12 in the manner described above.

It should be appreciated that the present invention provides numerous advantages. For instance, because the electronic circuit assembly 124 is pre-assembled, it facilitates the assembly of the stand 10. More particularly, the LEDs 188, 212 are pre-mounted on the strips 164, 166, respectively, they need not be individually connected to the strips 164, 166 during the assembly of the stand 10, thereby making the overall manufacturing of the stand 10 efficient and cost effective.

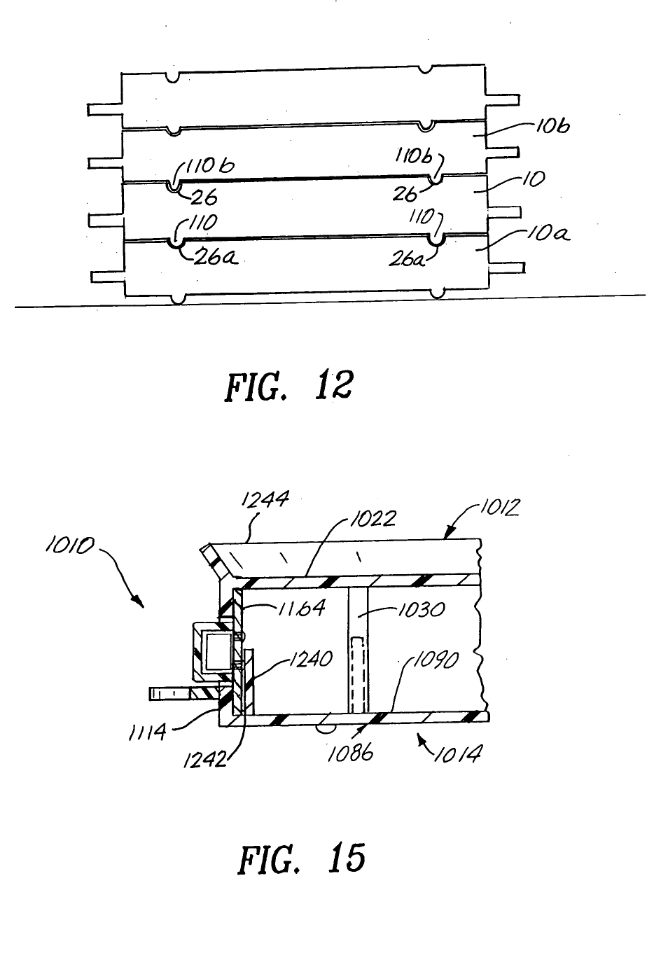

The support pegs 110 and the outer groove 26 of the stand 10 also allow the stand 10 to be stacked with identical stands (see FIG. 12). More particularly, the support pegs 110 are sized and shaped so as to be received in an outer groove 26a of an identical stand 10a positioned immediately below the stand 10, while the outer groove 26 of the stand 10 is sized and shaped so as to receive support pegs 110b of an identical stand 10b stacked on the stand 10. In this manner, the height of the entire stack is less than the height of a stack of stands without similar grooves and pegs, thereby allowing more stands to be stored in a given space in a more secure manner.

It should be noted that the present invention can have numerous modifications and variations. For instance, the electronic circuit assembly 124 can be programmed such that when it is activated by depressing the button 156, it automatically terminates the generation of special effects after the lapse of a predetermined time period. As a result, the button 158 and the switch circuit associated therewith can be eliminated (i.e., only one button and switch circuit can be provided for activating the LEDs 188, 212). When only one button is provided, the electronic circuit assembly 124 can be programmed such that the LEDs 188, 212 are operated by a number of different ways of activating the single button (e.g., the number of clicks and the duration of depressing the button). By way of example, the electronic circuit assembly 124 can be programmed such that if the button is depressed for a short period of time, the LEDs 188, 212 are activated for testing purposes (i.e., they are turned off automatically after a lapse of a certain time period). If the button is pressed for a long period of time, the LEDs 188, 212 can be activated continuously until the button is depressed again.

The retainers 78, 80 can also be eliminated. In such circumstances, another support bar can be mounted to the support column 30 located diagonally opposite to the switch leaf 66a. The strips 164, 166 can also be positioned in different orientations with respect to the circuit board 126 and/or the stand 10. In addition, the strips 164, 166 can be glued to the upper section 12, thereby eliminating the need to provide the support bars 218 and the retainers 78, 80.

The retainers 78 and 80 can also be modified. For instance, if the LEDs 188, 212 have smaller sizes such that their free ends 217 do not extend beyond the slots 74 (see FIG. 13), a leg 84 can be provided for each of the retainers 78, 80, extending substantially perpendicularly from a corresponding one of the retainers 78, 80. More particularly, because the LEDs 188, 212, due to their smaller sizes, can be inserted into the slots 74 vertical downwardly, the legs 84 of the retainers 78, 80 would not interfere with the vertical insertion of the adjacent LEDs 188, 212 into the corresponding slots 74.

The LEDs 188, 212 can also be provided with different shapes (e.g., cylindrical or round) and sizes and be replaced with other types of lighting units. As a result, the slots 74 can be provided with different sizes and shapes to accommodate differently shaped and/or sized LEDs. The slots 74 can also be positioned in different locations on the stand 10.

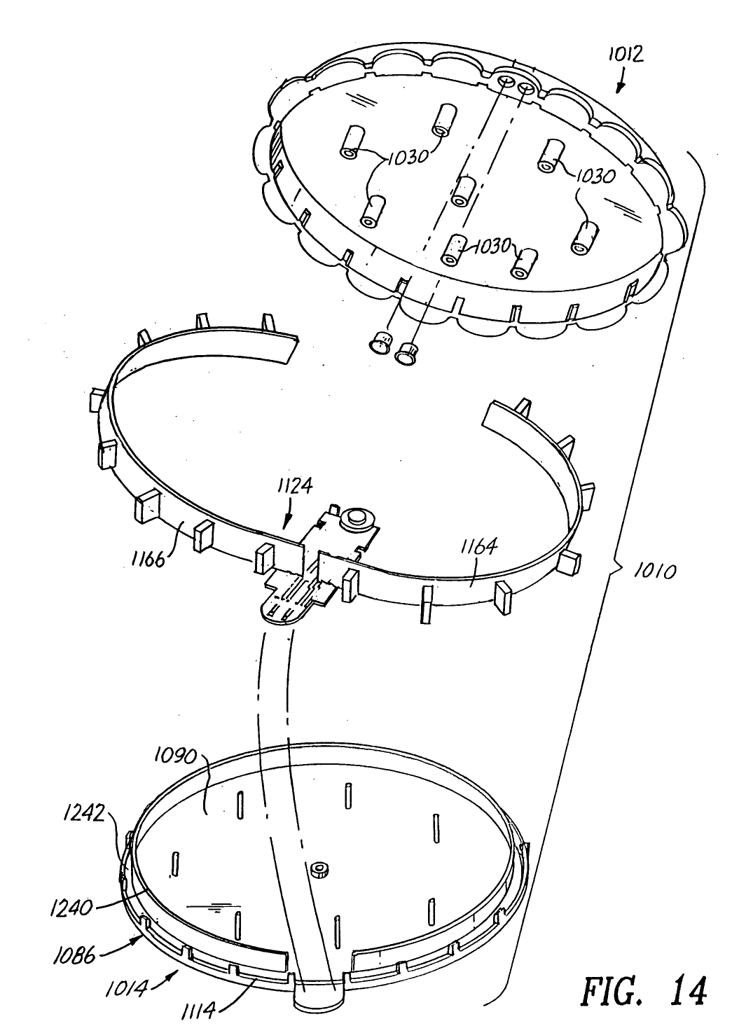

FIGS. 14-23 illustrate alternate embodiments of the present invention. Elements illustrated in FIGS. 14-23, which correspond, either identically or substantially, to the elements described above with respect to the embodiment of FIGS. 1-13, have been designated by corresponding reference numerals successively increased by an increment of one thousand. Unless otherwise stated, the embodiments of FIGS. 14-23 are constructed and assembled and operate in the same basic manner as the embodiment of FIGS. 1-13.

With reference to FIGS. 14 and 15, a cake stand 1010 constructed in accordance with a second embodiment of the present invention includes upper and lower sections 1012, 1014. The lower section 1014 includes a base 1086 having an upper side 1090. An annular retaining wall 1240 projects upwardly from the upper side 1090 of the base 1086. The retaining wall 1240 is formed inwardly from a side wall 1114 and is positioned coaxially with respect to the side wall 1114. The retaining wall 1240 and the side wall 1114 cooperate to form an annular channel 1242 therebetween adapted for receiving strips 1164, 1166 of an electronic circuit assembly 1124 of the stand 1010 and retaining the strips 1164, 1166 therein in their curved form. Due to the provision of the retaining wall 1240 and the channel 1242, the stand 1010 is not provided with devices similar to the retainers 78, 80 or the support bars 218 of the embodiment of FIGS. 1-13. As a result, support columns 1030 of the stand 1010 are not provided with stops similar to the stops 36 of the stand 10 shown in FIGS. 1-13. The stand 1010 can also be provided with a rim 1244 extending upwardly and outwardly from an upper side 1022 of the upper section 1012 for retaining food items on the upper side 1022.

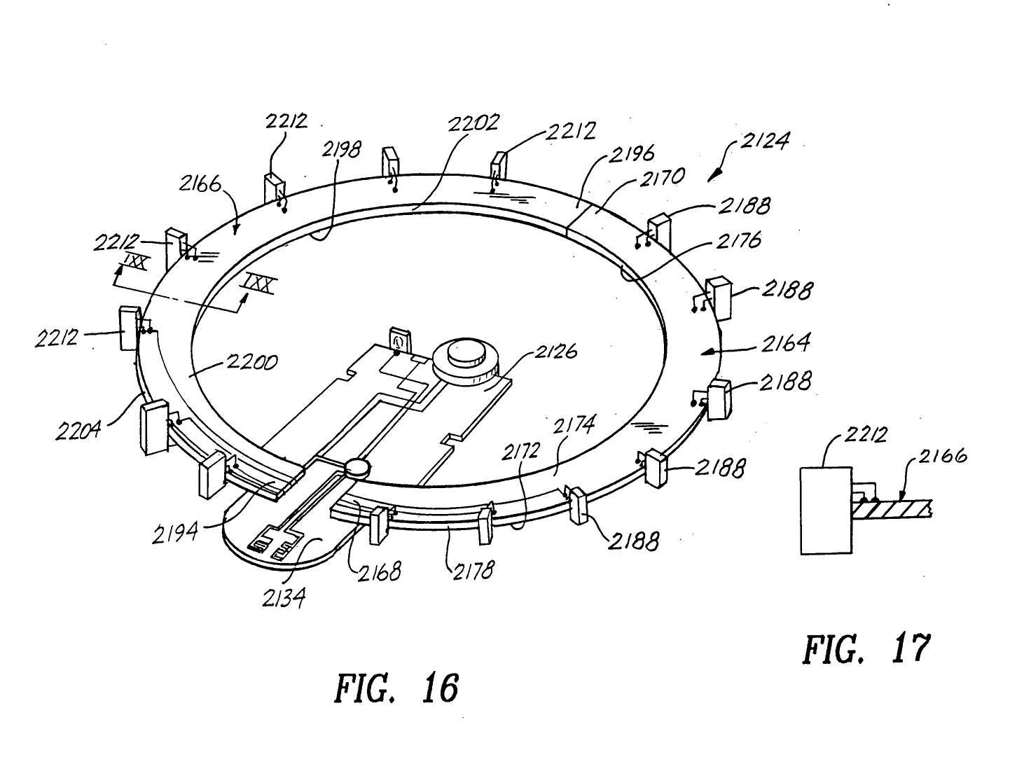

FIGS. 16 and 17 show an electronic circuit assembly 2124 for a cake stand (not shown) constructed in accordance with a third embodiment of the present invention. The electronic circuit assembly 2124 includes a pair of printed circuit board strips 2164, 2166. More particularly, each of the strips 2164, 2166 is cut from a sheet of printed circuit board material in an arcuate shape. As a result, each of the strips 2164, 2166 is normally in its arcuate shape without bending. The strip 2164 is provided with lower and upper sides 2172, 2174, a pair of ends 2168, 2170 and inner and outer edges 2176, 2178, while the strip 2166 is provided with lower and upper sides 2198, 2200, a pair of ends 2194, 2196 and inner and outer edges 2202, 2204. The lower sides 2172, 2198 of the strips 2164, 2166, respectively, are mounted to a printed circuit board 2126 such that the lower and upper sides 2172, 2174 of the strip 2164 and the lower and upper side 2198, 2200 of the strip 2166 are substantially parallel to an upper side 2134 of the circuit board 2126. The ends 2170, 2196 of the strips 2164, 2166, respectively, are attached (e.g., soldered or glued) to one another such that the strips 2164, 2166 form a substantially circular edge defined by the outer edges 2178, 2204 for mounting LEDs 2188, 2212, respectively, thereto. More particularly, the LEDs 2188 and 2212 have leads which are soldered to the upper sides 2174, 2200, respectively, or the lower sides 2172, 2198, respectively, of the strips 2164, 2166, respectively.

Because the strips 2164, 2166 are normally in their arcuate shape, the electronic circuit assembly 2124 is not provided with shape-retaining mechanisms similar to those of the embodiments of FIGS. 1-15 (e.g., the retainers 78, 80 and the support bars 218 of the stand 10 shown in FIGS. 1-13 and the retaining wall 1240 and the channel 1242 of the stand 1010 shown in FIGS. 14 and 15) in order to be mounted in an associated stand. Other retaining mechanisms can be optionally provided for securing the electronic circuit assembly 2124 in the cake stand.

It should be noted that the electronic circuit assembly 2124 can have numerous modifications and variations. For instance, the strips 2164, 2166 can be made as a single piece. Alternatively, each of the strips 2164, 2166 can be made into multiple pieces. In addition, the LEDs 2188, 2212 can also be mounted to different locations on the strips 2164, 2166. Moreover, the strips 2164, 2166 can be modified so as to have different overall shapes (e.g., rectangular, triangular, hexagonal or oval shapes).

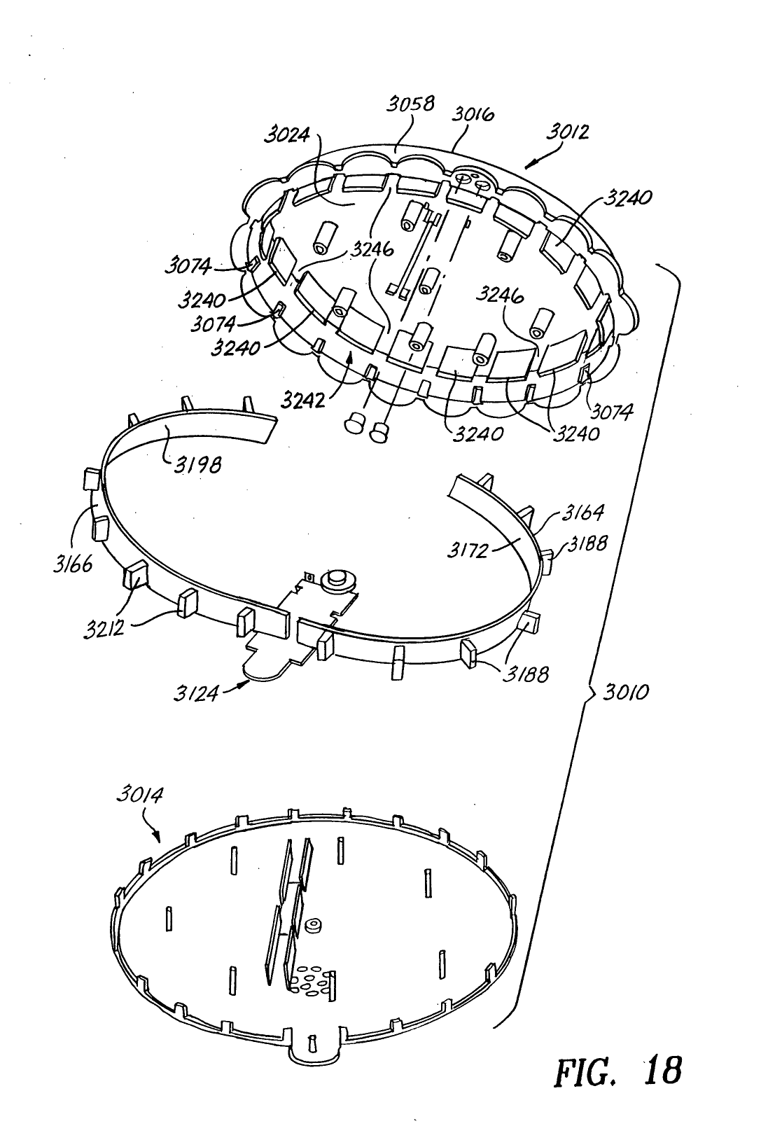

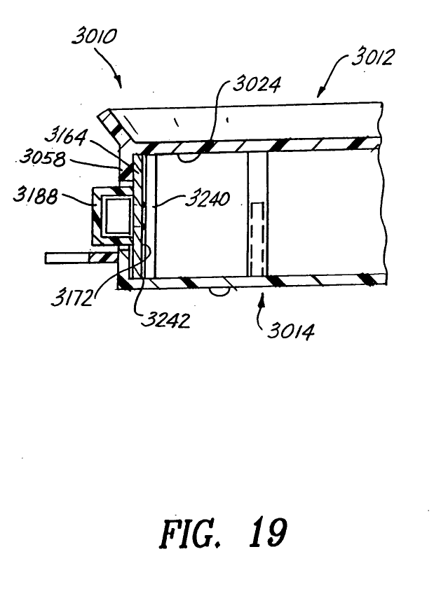

FIGS. 18 and 19 show a cake stand 3010 constructed in accordance with a third embodiment of the present invention. The cake stand 3010 is constructed and assembled in the same basic manner as the embodiment of FIGS. 14 and 15, except as discussed hereinbelow. The cake stand 3010 includes upper and lower sections 3012, 3014. The upper section 3012 includes a platform 3016 having a lower side 3024. Retaining wall sections 3240 depend downwardly from the lower side 3024 of the platform 3016. The wall sections 3240 are arranged radially inwardly from a side wall 3058 and arranged in an annular shape so as to cooperate with the side wall 3058 to form an annular channel 3242 therebetween. Like the channel 1242 of the embodiment of FIGS. 14 and 15, the channel 3242 is adapted to receive strips 3164, 3166 of an electronic circuit assembly 3124 of the cake stand 3010 and to retain the strips 3164, 3166 therein in their curved form. A space 3246 is formed between each adjacent pair of the wall sections 3240. Each of the spaces 3246 is aligned with a corresponding one of a plurality of slots 3074 formed in the side wall 3058. More particularly, because solders are formed on inner sides 3172, 3198 of the strips 3164, 3166, respectively, to secure leads of the LEDs 3188, 3212, respectively, thereto, the strips 3164, 3166 are thicker at locations where the LEDs 3188, 3212 are attached. The spaces 3246 hence facilitate the insertion of the LEDs 3188, 3212 into the slots 3074. The wall sections 3240 can be formed as a single piece or as a plurality of pins.

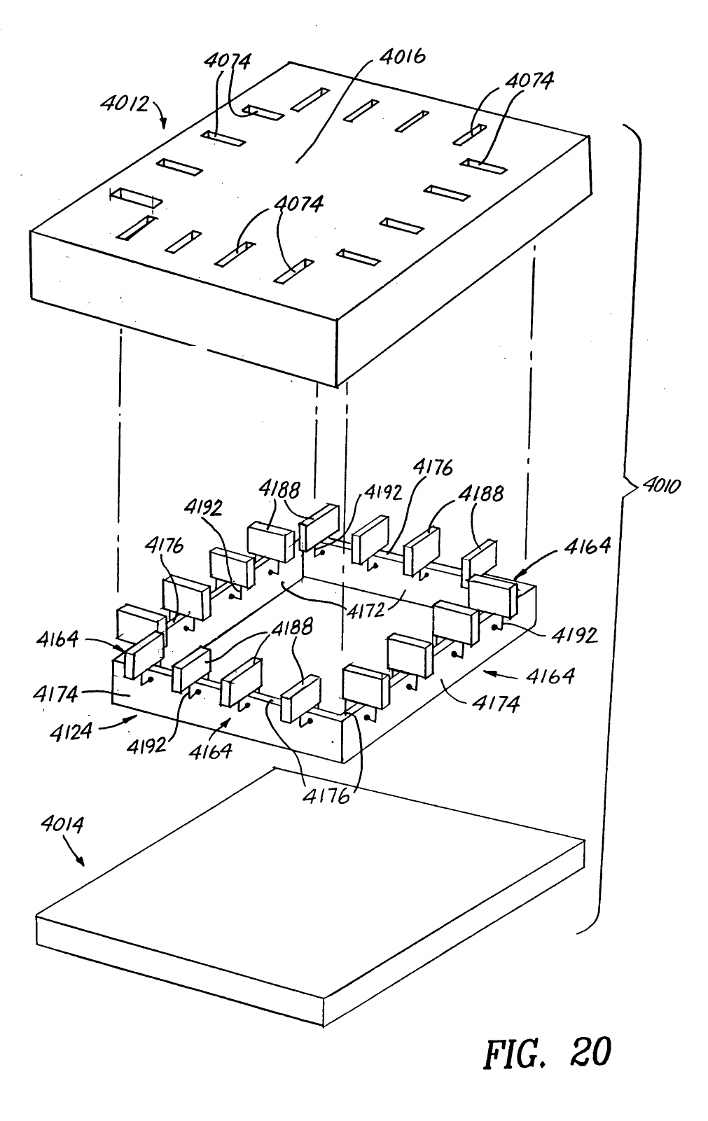

FIG. 20 shows a cake stand 4010 constructed in accordance with a fifth embodiment of the present invention. The cake stand 4010 is constructed and assembled in the same basic manner as the embodiment of FIGS. 16 and 17, except as discussed hereinafter. The cake stand 4010 has an upper section 4012 and a lower section 4014 attached to each other. Each of the upper and lower sections 4012, 4014 has a rectangular shape. The upper sections 4012 has a platform 4016 having a plurality of openings 4074 formed therein and arranged in a rectangular shape. The cake stand 4010 also has a plurality of LEDs 4188 and an electronic circuit assembly 4124 for activating the LEDs 4188 in a predetermined fashion. The electronic circuit assembly 4124 has four printed circuit board strips 4164 attached (e.g., soldered or glued) to each other so as to form and maintain a rectangular structure. Each of the strips 4164 has an upper edge 4176. The LEDs 4188 are positioned on or above the upper edges 4176 of the strips 4164. Conductive leads 4192 of each of the LEDs 4188 are attached to inner and outer sides 4172, 4174 of a corresponding one of the strips 4164. Alternatively, both of the leads 4192 of each of the LEDs 4188 can be attached to one of the inner and outer sides 4172, 4174. The electronic circuit assembly 4124 is mounted in the cake stand 4010 between the upper and lower sections 4012, 4014 such that each of the LEDs 4188 extends outwardly from the platform 4016 through a corresponding one of the openings 4074. It should be noted that the strips 4164 can be made so as to have different geometrical shapes (e.g., oval, circular, triangular, octagonal and hexagonal shapes, etc.) for accommodating cake stands having similar shapes. The LEDs 4188 can also be mounted on the outer sides 4174 of the strips 4164.

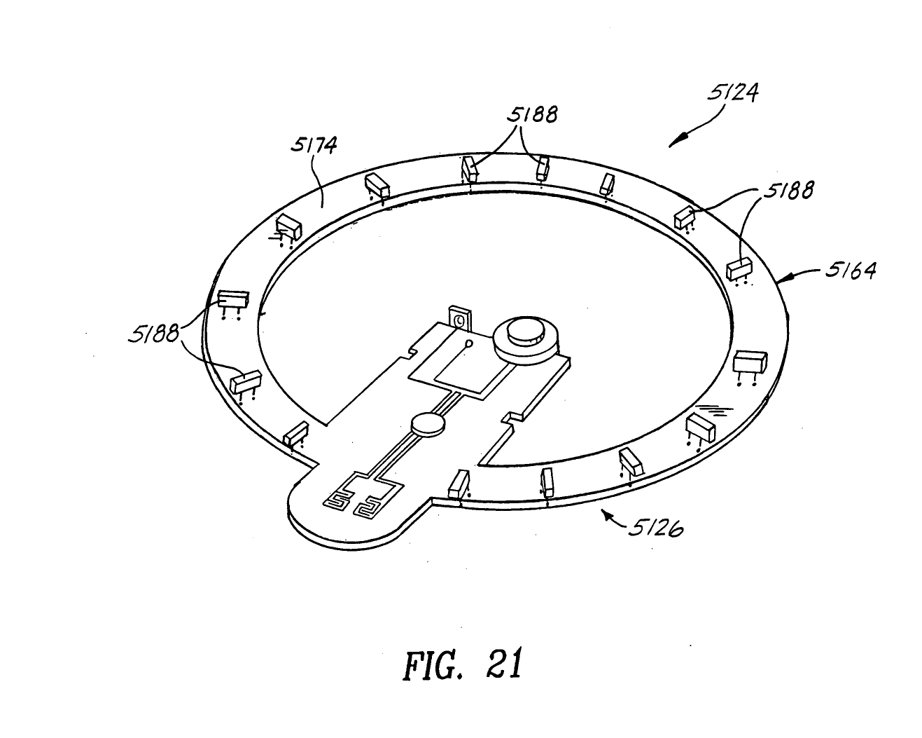

FIG. 21 shows an electronic circuit assembly 5124 for a cake stand (not shown) constructed in accordance with a sixth embodiment of the present invention. The electronic circuit assembly 5124 is constructed and assembled in the same basic manner as the embodiment of FIGS. 16 and 17, except as discussed hereinbelow. The electronic circuit assembly 5124 includes a printed circuit board 5126 having a strip section 5164 formed integrally therewith. The strip section 5164 is provided with an upper side 5174. LEDs 5188 are mounted on the upper side 5174 and are hence arranged in a circular shape. Like the LEDs 4188 of the embodiment of FIG. 20, the LEDs 5188 are adapted to extend through openings formed in a platform of an upper section of the cake stand.

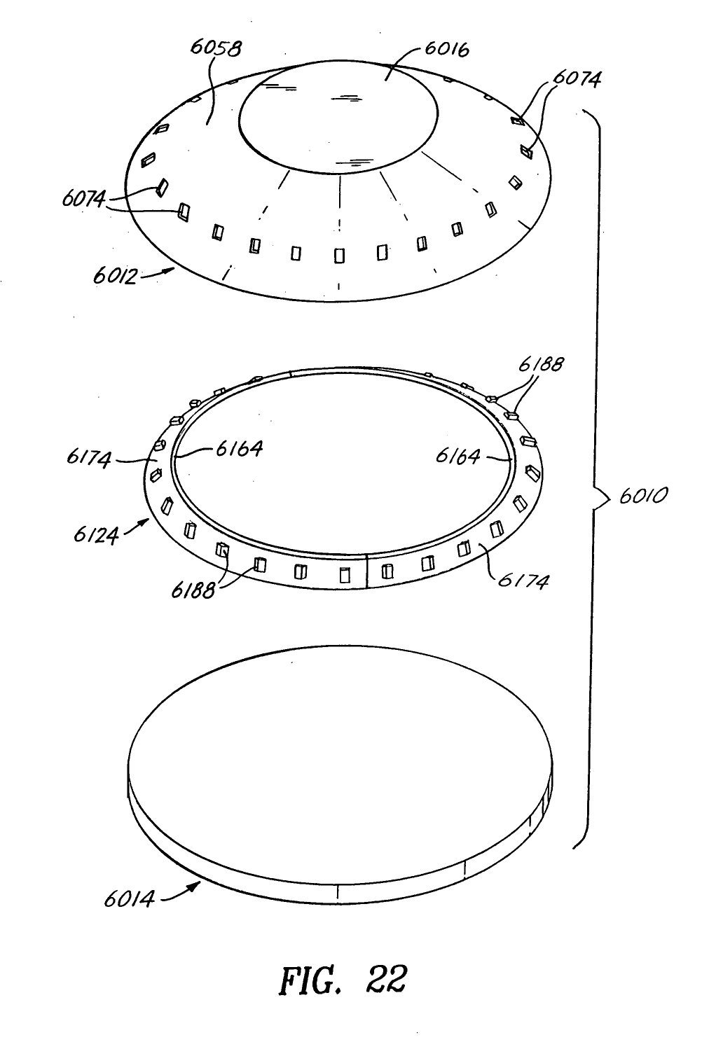

FIG. 22 shows a cake stand 6010 constructed in accordance with a seventh embodiment of the present invention. More particularly, the cake stand 6010 includes upper and lower sections 6012, 6014. The upper section 6012 includes a platform 6016 and a slanted or sloped side wall 6058. Openings 6074 are formed in the sloped side wall 6058. The cake stand 6010 also includes an electronic circuit assembly 6124 having a plurality of printed circuit board strips 6164 arranged and curved so as to form a frusto-conical structure. LEDs 6188 are mounted to slanted or sloped outer sides 6174 of the strips 6164 for insertion into the openings 6074 of the upper section 6012.

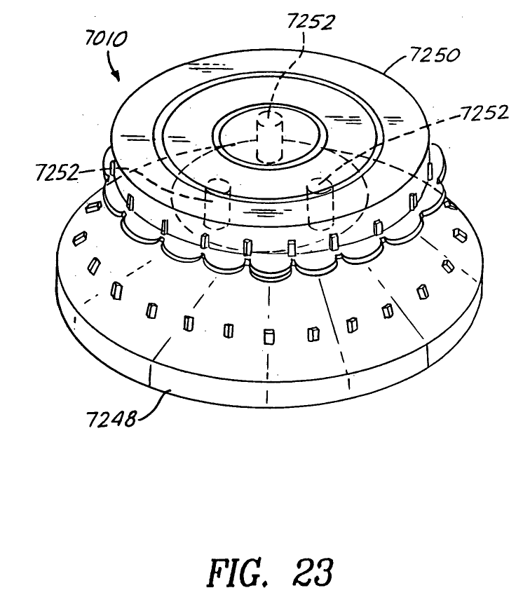

FIG. 23 illustrates a cake stand 7010 constructed in accordance with an eighth embodiment of the present invention. The cake stand 7010 has a lower tier 7248 and an upper tier 7250. The lower tier 7248 has a construction and operation identical to those of the embodiment shown in FIG. 22, while the upper tier 7250 has a construction and operation identical to those of the embodiment shown in FIGS. 1-13. Pillars 7252 are mounted on the lower tier 7248 for supporting the upper tier 7250 above the lower tier 7248 such that a cake can be displayed on the upper tier 7250.

It will be understood that the embodiments described herein are merely exemplary and that a person skilled in the art may make many variations and modifications without departing from the spirit and scope of the invention. All such variations and modifications, including those discussed above, are intended to be included within the scope of the invention as defined by the appended claims.

I claim:

1. A device for supporting an article thereon, comprising a case having a plurality of openings therein; a plurality of light units mounted in said case, each of said light units having a portion extending outwardly through a corresponding one of said openings; at least one strip having a plurality of conductive paths deposited thereon, each of said light units being attached to said at least one strip such that it is connected to a corresponding pair of said conductive paths; and a printed circuit board mounted in said case and including controlling means for controlling the operation of said light units, said at least one strip being attached to said board such that said controlling means is electrically connected to said conductive paths.

2. The device of claim 1, wherein said at least one strip is a component which is separate from said board, said board including a plurality of conductive paths deposited thereon and connected to said controlling means, each of said conductive paths of said at least one strip being connected to a corresponding one of said conductive paths of said board at an interface between said at least one strip and said board.

3. The device of claim 2, wherein said case includes a substantially horizontal surface for supporting an article thereon, said board being oriented substantially parallel to said surface of said case, said at least one strip projecting substantially vertically from said board, said at least one strip having a substantially vertical side, each of said light units being permanently attached to said side of said at least one strip.

4. The device of claim 3, wherein said case has a substantially circular side wall depending from said surface of said case, said openings being formed in said side wall, said at least one strip being bent into an arcuate shape such that it is positioned radially inwardly from said side wall and located adjacent thereto, each of said light units projecting outwardly from said side of said at least one strip through a corresponding one of said openings.

5. The device of claim 4, further comprising maintaining means for maintaining said arcuate shape of said at least one strip in said case.

6. The device of claim 5, wherein said maintaining means includes a plurality of support bars mounted in said case and engaging said at least one strip so as to urge said at least one strip against said side wall of said case.

7. The device of claim 5, wherein said maintaining means includes an annular retaining wall positioned radially inwardly from said side wall and forming an annular channel between said retaining wall and said side wall, said at least one strip being positioned in said channel.

8. The device of claim 4, wherein said at least one strip includes an end attached to said board, said end of said at least one strip having a plurality of teeth, said board including a plurality of holes, each of which is sized and shaped so as to receive a corresponding one of said teeth, at least one of said light units being attached to said at least one strip adjacent said end, said holes being arranged in a linear fashion so as to inhibit the bending of said end of said at least one strip.

9. The device of claim 4, wherein said case includes guiding means for guiding the insertion of each of said light units into a corresponding one of said openings of said case, said guiding means including a plurality of guiding members mounted in said case, each of said openings being positioned between a corresponding pair of said guiding members.

10. The device of claim 1, wherein said at least one strip includes first and second strips, each of which is attached to said board, each of said first and second strips being bent into a substantially semi-circular shape and is positioned in said case with respect to one another such that said light units are arranged in a substantially circular fashion.
